(19) United States
(12) Patent Application Publication
(10) Pub. No.: US 2007/0195223 A1
(43) Pub. Date: Aug. 23, 2007

(54) LIQUID CRYSTAL DISPLAY DEVICE

(76) Inventors: Seiichi NISHIYAMA, Mobara (JP); Hisao Hirayama, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/677,651

(22) Filed: Feb. 22, 2007

(30) Foreign Application Priority Data
Feb. 22, 2006 (JP) 2006-045335

(51) Int. Cl. G02F 1/1335

(52) U.S. Cl. 349/64

(57) ABSTRACT

A liquid crystal display device is provided which reduces the weight and cost of a backlight unit and decreases occurrence of brightness spots on the display surface of a liquid crystal display panel.

The liquid crystal display device includes: a liquid crystal display panel PNL configured to have a liquid crystal layer sandwiched between a pair of transparent substrates each having a pixel-forming electrode on an inner surface thereof; a backlight BL having a cold cathode fluorescent lamp CFL emitting illumination light to the rear face of the liquid crystal display panel PNL; an optical compensation sheet OPS interposed between the liquid crystal display panel PNL and the backlight BL; frames UFL, DFL housing the liquid crystal display panel PNL and the backlight BL therein. At least single light diffusion film DFF is interposed between the optical compensation sheet OPS and the backlight BL and at least the single light diffusion film DFF is fixedly retained on at least an upper side of a casing region of the upper frame UFL by a screw SC.

### CLAIM OF PRIORITY

The present application claims priority from Japanese Application JP 2006-045335 filed on Feb. 22, 2006, the content of which is hereby incorporated by reference into this application.

### BACKGROUND OF THE INVENTION

1. Field of the Invention

The present invention relates generally to a liquid crystal display device with a direct type backlight. In particular the invention relates to a light diffusion structure which is interposed between a liquid crystal display panel and a backlight to diffuse light source light from the backlight to the back face of the liquid crystal display panel.

2. Description of the Related Art

An image display device using a liquid crystal display panel which is of a nonradiative type is provided with external lighting means so as to visualize an electronic latent image formed on the liquid crystal display panel. The external lighting means includes a lighting system installed on the rear or front of the liquid crystal display panel except a structure using natural light. In particular, for a display device requiring high intensity, a structure in which a lighting system is installed on the rear of a liquid crystal display panel becomes the mainstream. This is called a backlight.

The backlight is broadly classified into a side edge type and a direct type. The side edge type is structured such that a linear light source represented by a cold cathode fluorescent lamp is installed along the side edge of a light guide plate made of a transparent plate. The side edge type is often used in a display device requiring thinning such as a personal computer. On the other hand, the direct type is often used in a large-sized liquid crystal display device such as a display device used for a display monitor or a television set. A direct backlight has a structure in which a lighting system is installed immediately under the rear of a liquid crystal display panel.

FIG. 3 is a cross-sectional view of an essential part for assistance in explaining the configuration of a liquid crystal device using a direct backlight of such a type. In FIG. 3, a liquid crystal display panel PNL is formed by sealing a liquid crystal layer between glass substrates having pixel-forming electrodes. An optical compensation sheet OPS formed by laminating a plurality of kinds of optical compensation sheets is installed on the rear side of the liquid crystal display panel PNL. This optical compensation sheet OPS is formed by laminating a prism sheet PRZ, a diffusion sheet DFS and the like in this order from near the liquid crystal display panel PNL.

A backlight BL is installed on the back side of the optical compensation sheet OPS. The backlight BL is configured such that a reflection plate RFP is installed in a lower frame DFL and a plurality of cold cathode fluorescent lamps CFL are installed parallel to each other on the reflection plate RFP. The lower frame DFL is formed of a metal plate and similarly an upper frame UFL is formed of a metal plate. The optical compensation sheet OPS and a diffusion plate DFP made of a translucent resin material and also having light guide performance are interposed between the lower frame DFL and the upper frame UFL. The lower frame DFL and the upper frame UFL are fastened to each other with screws SCR. The liquid crystal display panel PNL is mounted on a casing region of the upper frame UFL.

The direct backlight of such a type is configured as below. The diffusion plate DFP is disposed between the liquid crystal display panel PNL and the plurality of cold cathode fluorescent lamps CFL arranged parallel to each other so as to define a space between the diffusion plate DFP and the cold cathode fluorescent lamps CFL. The optical compensation sheet OPS composed of the diffusion sheet DFS, the prism sheet PRZ and the like are disposed between the diffusion plate DFP and the liquid display panel PNL. The diffusion plate DFP is made of a resin material having a thickness of about 2 mm and contains an optical diffusion agent.

There are mainly two purposes of using the diffusion plate DFP. A first purpose is to substantially uniformize the brightness distribution in the irradiation plane of the backlight BL by allowing the light diffusion agent contained in the resin material to diffuse light from the cold cathode luminescent lamps. A second purpose is to cause the diffusion plate to retain the optical compensation sheet OPS such as the diffusion sheet DFS, the prism sheet PRZ and the like disposed thereon by making the thickness of the resin material about 2 mm to give mechanical strength to the diffusion plate.

### SUMMARY OF THE INVENTION

However, the diffusion plate DFP of the backlight BL applied to such a large-size liquid crystal display device has problems described below.

(1) Since the diffusion plate DFP has a thickness of about 2 mm, the total weight of the backlight BL is increased.

(2) Since the diffusion plate DFP has a thickness of about 2 mm, the used amount of the resin material is more than that of the diffusion sheet DFS. Therefore, the cost of the diffusion plate DFP is higher than that of the diffusion sheet DFS.

(3) Generally, the diffusion plate DFP uses a resin material such as an acryl resin, an MS resin, or polycarbonate. These materials have hygroscopicity. Therefore, when the cold cathode fluorescent lamps CFL of the backlight BL are lit, moisture released from the surface of the diffusion plate DFP on the side of the light source is more than that released from the surface of the liquid crystal display panel PNL. As shown in the cross-sectional view of FIG. 4, this deforms the diffusion plate DFP so as to protrude toward the liquid crystal display panel PNL (occurrence of warpage). Consequently, the protrudently deformed diffusion plate DFP pushes up the central portion of the liquid crystal display panel PNL via the optical compensation sheet OPS. The deformation and pushing-up causes a wavy phenomenon in the optical compensation sheet OPS, resulting in brightness spots on the display surface of the liquid crystal display panel PNL.

Thus, the present invention has been made to solve the existing problems described above and it is an object of the invention to provide a liquid crystal display device that reduces the weight and cost of a backlight unit and that decreases occurrence of brightness spots on the display surface of a liquid crystal display panel.

To achieve such an object, according to an aspect of the present invention, there is provided a liquid crystal display device including: a liquid crystal display panel configured to have a liquid crystal layer sandwiched between a pair of transparent substrates each having a pixel-forming electrode on an inner surface thereof; a backlight having a light source emitting illumination light to the rear face of the liquid crystal display panel; an optical compensation sheet interposed between the liquid crystal display panel and the backlight; a frame housing the liquid crystal display panel and the backlight therein; wherein at least a single light diffusion film is interposed between the optical compensation sheet and the backlight, and at least the single light diffusion film is fixedly retained on at least an upper side of a casing region of the frame by a retaining member.

According to another aspect of the present invention, there is provided a liquid crystal display device including: a liquid crystal display panel configured to have a liquid crystal layer sandwiched between a pair of transparent substrates each having a pixel-forming electrode on an inner surface thereof; a backlight having a light source emitting illumination light to the rear face of the liquid crystal display panel; an optical compensation sheet interposed between the liquid crystal display panel and the backlight; and a frame housing the liquid crystal display panel and the backlight therein; wherein a translucent film is interposed between the optical compensation sheet and the backlight and the translucent film is fixedly retained on at least an upper side of a casing region of the frame.

Since a heavyweight diffusion plate can be eliminated, the weight saving and cost reduction of the backlight unit can be realized and occurrence of brightness spots on the display surface of the liquid crystal display panel can be suppressed. Thus, the present invention has a significantly excellent effect that a liquid crystal display device reduced in cost and exhibiting high-grade-display can be provided.

### BRIEF DESCRIPTION OF THE DRAWINGS

FIG. 1 is a cross-sectional view of an essential part for assistance in explaining the configuration of a liquid crystal display device according to a first embodiment of the present invention;

FIG. 2 is a cross-sectional view of an essential part for assistance in explaining the configuration of a liquid crystal display device according to a second embodiment of the present invention;

FIG. 3 is a cross-sectional view of an essential part for assistance in explaining the configuration of an existing liquid crystal display device; and

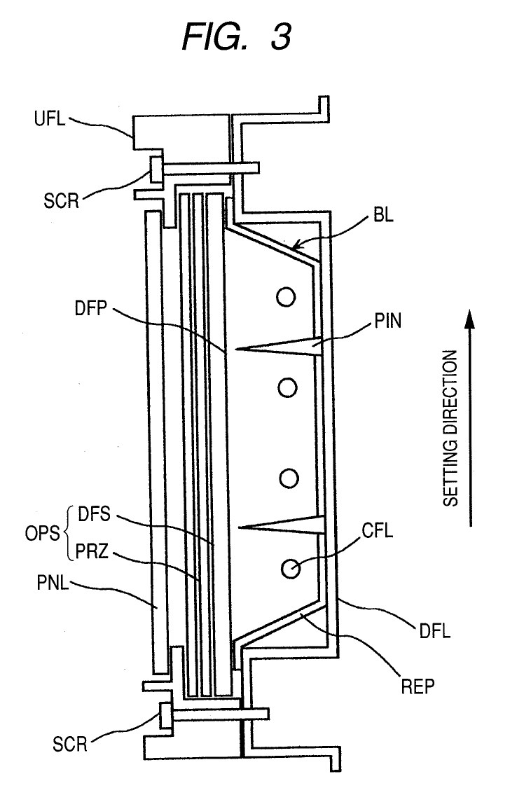

FIG. 4 is a cross-sectional view of an essential part for assistance in explaining the problems of the existing liquid crystal display device.

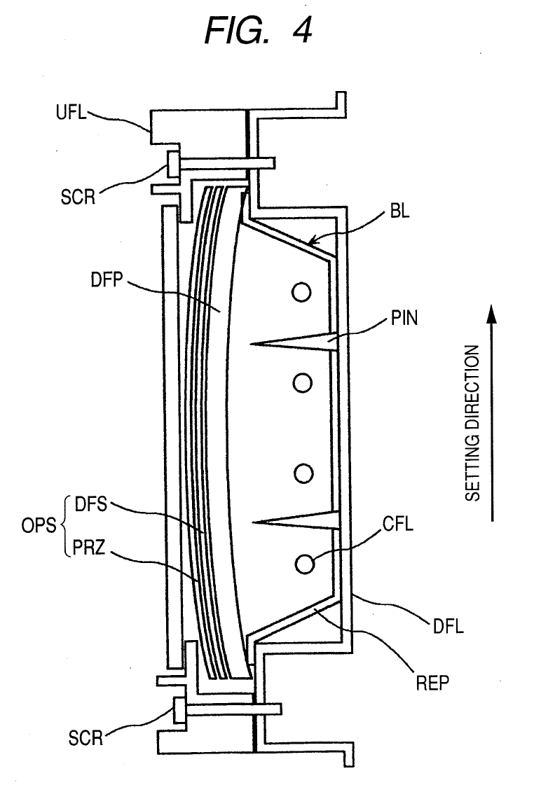

### DETAILED DESCRIPTION OF THE PREFERRED EMBODIMENTS

Hereinafter, specific embodiments of the present invention will be described in detail with reference to the drawings. In the drawings referred to in the following description, like reference numerals denote elements having like or corresponding functions and duplicate explanation is omitted as much as possible.

### First Embodiment

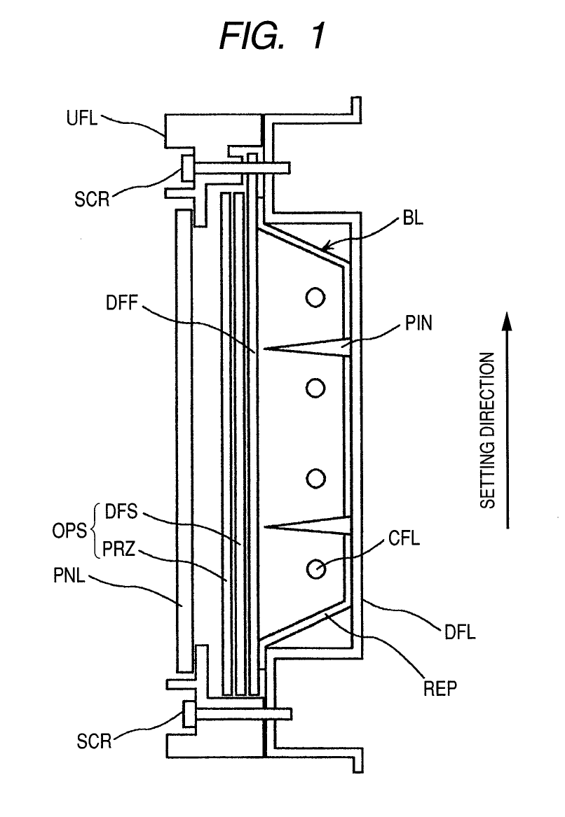

FIG. 1 is a cross-sectional view of an essential part illustrating the entire configuration of a liquid crystal display device according to a first embodiment of the present invention. The same portions as in the figures described earlier are denoted with the same reference numerals and their explanations are omitted. In FIG. 1, a liquid crystal display panel PNL includes, not shown, a plurality of drive circuits mounted on the circumferential edge portion of a liquid crystal cell and a printed circuit board supplying signals to the drive circuits. The liquid crystal cell includes a pair of translucent glass substrates each having a pixel-forming electrode on the inner surface thereof and a liquid crystal layer sandwiched between the translucent glass substrates. In addition, a pair of polarizing plates, not shown, are respectively arranged to be laminated to the front and rear faces of the liquid crystal cell.

An optical compensation sheet laminated body OPS is installed on the rear side of the liquid crystal display panel PNL. The laminated body OPS is formed by sequentially laminating a prism sheet PRZ, a diffusion sheet DFS and others in this order from the side of the liquid crystal display panel PNL. In addition, a light diffusion film DFF having a light diffusion function is installed on the rear side of the optical compensation sheet OPS.

The optical compensation sheet OPS and the light diffusion film DFF are laminated to each other and installed so as to be supported by the upper and lower sides, in the casing region, of the upper frame UFL. The light diffusion film DFF contains, e.g. PET or a polycarbonate resin material as a main ingredient and is formed as a thin film. It has a thickness of about 0.1 to 0.2 mm and has such flexibility as to be bendable with small stress.

In order to possess light diffusion property, the light diffusion film DFF is formed by coating beads having a small particle diameter and made of the same resin on the surface of the film main body thereof. Alternatively, a microasperity surface is formed on the surface of the film main body. Further, a treatment such as impregnating the film main body with a light diffusion agent is performed.

The backlight BL adapted to project illumination light on the rear of the liquid crystal display panel PNL is installed on the rear side of the optical compensation sheet OPS. The backlight BL includes e.g. a plurality of cold cathode fluorescent lamps CFL as a light source; a reflection plate RFP which also serves to fixedly support both ends of the cold cathode fluorescent lamp CFL and has a reflection surface integrally formed on the side faces and bottom face thereof; and at least one pin PIN used to support the light diffusion film DFF. Such components are assembled in and fixedly supported by the metallic lower frame DFL at their respective predetermined positions.

The optical compensation sheet OPS and the light diffusion film DFF supported in and by the casing region of the upper frame UFL are assembled with the lower frame DFL. In addition, the upper frame UFL and the lower frame DFL are fixedly retained by screws SCR at plurality of positions on the upper and lower sides of the casing region. In this case, only the light diffusion film DFF installed close to the cold cathode fluorescent lamps CFL is penetrated by an screw SCR so as to be sandwiched between the upper frame UFL and the lower frame DFL. Incidentally, the liquid crystal display panel PNL is installed on and fixedly retained by the casing region of the upper frame UFL.

With the liquid display device configured described above, light emitted from the cold cathode fluorescent lamps CFL and light reflected by the reflection plate RFP are mixed and diffused. The mixed and diffused light is further light-diffused by the light diffusion film DFF. The diffused light transmits the optical compensation sheet OPS and is directed to the rear of the liquid crystal display panel PNL at high brightness. Consequently, the electronic latent image formed on the liquid crystal display panel PNL is visualized.

According to such a configuration, the thin light diffusion film DFF is used as light diffusion means for the plurality of cold cathode fluorescent lamps constituting the backlight BL and is fixedly retained in the casing region of the upper frame UFL using the screws SCR. It is hard for the light diffusion film DFF to come close to the cold cathode fluorescent lamps CFL. The light diffusion film DFF becomes less susceptible to deformation such as waves (undulation). The optical compensation sheep OPS will not be pressed up toward the liquid crystal display panel PNL. Thus, display-related defects will not occur, such as the occurrence of brightness spots on the display surface of the liquid crystal display panel PNL.

In addition, according to such a configuration, the light diffusion film DFF having a thickness of as thin as about 0.1 to 0.2 mm diffuses light toward the rear of the light compensation sheet OPS. This provides light diffusion property approximately equal to that of the existing light diffusion plate having a thickness of about 2 mm without using the existing light diffusion plate. Thus, the weight saving and cost reduction of the liquid crystal display device can be achieved concurrently and easily.

Incidentally, the first embodiment describes the case where a single light diffusion film DFF is disposed on the backlight BL; however, the present invention is not limited to such a configuration. The same effect can be provided even if a plurality of the light diffusion films DFF are arranged in a laminated manner. The configuration mentioned above can improve the mechanical strength of the light diffusion films DFF.

In addition, the first embodiment describes the case where the light diffusion film DFF is fixedly retained on the opposite sides, namely, the upper and lower sides, of the casing region of the upper frame UFL using the screws SCR. However, the present invention is not limited to this. The light diffusion film DFF may be fixedly retained on only the upper side, while not on the other three sides.

If used as a liquid crystal television or a liquid crystal monitor, the liquid crystal display device configured as above uses the liquid crystal display module while vertically retaining it as shown in the figures. Therefore, it is needed only to fixedly retain the liquid crystal display module only on the upper side of the casing region. On the other hand, if the liquid crystal display module is fixedly retained on the other sides of the casing region, there is increased risk for occurrence of the wavy (undulate) phenomenon resulting from the thermal expansion of the light diffusion film DFF.

At least one pin PIN is disposed on the inside of the bottom surface of the backlight BL. These pins PIN prevent the light diffusion film DFF from coming close to the cold cathode fluorescent lamp CFL which is closest to the light diffusion film DFF. Therefore, the light diffusion film DFF becomes less susceptible to deformation.

### Second Embodiment

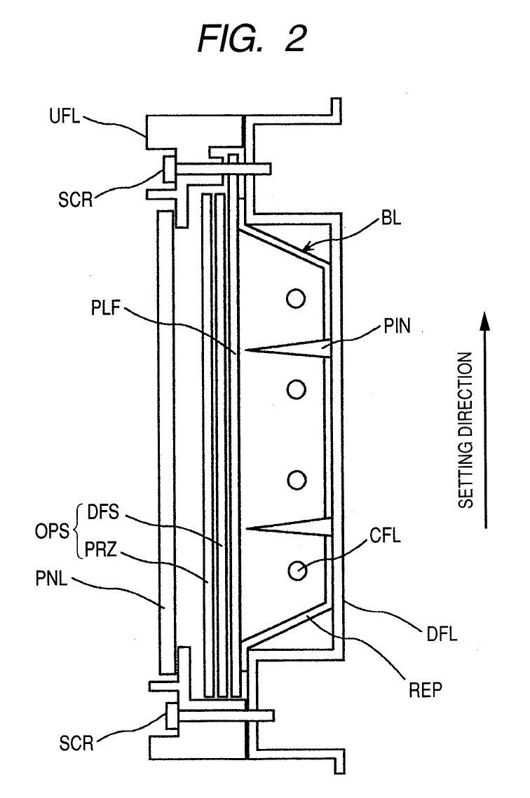

FIG. 2 is a cross-sectional view of an essential part for assistance in explaining the configuration of a liquid crystal display device according to a second embodiment of the present invention. The same portions as in the figures described earlier are denoted with the same reference numerals and their explanations are omitted. The configuration in FIG. 2 is different from that in FIG. 1 in that a translucent film PLF is installed on the rear side of the optical compensation sheet OPS. More specifically, the translucent film PLF is installed so as to be supported on the upper and lower sides, in the casing region, of an upper frame UFL with screws SCR.

The translucent film PLF contains, e.g. PET or a polycarbonate resin material as a main ingredient and is formed as a thin film. The translucent film PLF has a thickness of about 0.1 to 0.2 mm and has such flexibility as to be bendable with small stress. In short, the configuration of the second embodiment uses the translucent film PLF in place of the light diffusion film of the first embodiment.

According to such a configuration, since the translucent film PLF is disposed close to the cold cathode fluorescent lamp CFL, spots of brightness hardly occur when the translucent film PLF causes the wavy (undulate) phenomenon. Thus, display-related defects will not occur, such as occurrence of brightness spots on the display surface of the liquid crystal display panel PNL.

The light diffusion film DFF having the structure shown in FIG. 1 is interposed between the translucent film PLF and the optical compensation film OPS if required. This provides almost the same effect as that of the first embodiment.

The embodiments described above explain the case where the screws SCR are used as means for fixedly retaining the light diffusion film DDF and the translucent film PLF. However, the present invention is not limited to this case. Almost the same effect can be provided by using packings or the like made of rubber or resin instead of the screws SCR.

The so-called hanging structure may be used as the means for fixedly retaining the light diffusion film DDF and the translucent film PLF. In the hanging structure, a projecting portion having various shapes is integrally provided on the upper side portion of the casing region of the lower frame DFL so as to project toward the optical compensation sheet OPS. In addition, the light diffusion film DDF or the translucent film PLF is retained on the projecting portion using a screw, a packing or others.

What is claimed is:

1. A liquid crystal display device comprising:
a liquid crystal display panel configured to have a liquid crystal layer sandwiched between a pair of transparent substrates having a pair of pixel-forming electrodes on an inner surface thereof;
a backlight having a light source emitting illumination light to the rear face of the liquid crystal display panel;
an optical compensation sheet interposed between the liquid crystal display panel and the backlight; and
a frame housing the liquid crystal display panel and the backlight therein;
wherein at least single light diffusion film is interposed between the optical compensation sheet and the backlight and at least the single light diffusion film is fixedly retained on at least an upper side of a casing region of the frame by a retaining member.

2. The liquid crystal display device according to claim 1, wherein the light diffusion film is made of a PET resin material as a major ingredient.

3. The liquid crystal display device according to claim 1, wherein the light diffusion film is made of a polycarbonate resin material as a main ingredient.

4. The liquid crystal display device according to claim 1, wherein the light diffusion film has a thickness ranging from 0.1 to 0.2 mm.

5. The liquid crystal display device according to claim 1, wherein the retaining member is a screw.

6. The liquid crystal display device according to claim 1, wherein the retaining member is the frame or a packing.

7. A liquid crystal display device comprising:
a liquid crystal display panel configured to have a liquid crystal layer sandwiched between a pair of transparent substrates having a pair of pixel-forming electrodes on an inner surface thereof;
a backlight having a light source emitting illumination light to the rear face of the liquid crystal display panel;
an optical compensation sheet interposed between the liquid crystal display panel and the backlight; and
a frame housing the liquid crystal display panel and the backlight therein;
wherein a translucent film is interposed between the optical compensation sheet and the backlight and the translucent film is fixedly retained on at least an upper side of a casing region of the frame by a retaining member.

8. The liquid crystal display device according to claim 7, wherein the translucent film is made of a PET resin material as a main ingredient.

9. The liquid crystal display device according to claim 7, wherein the translucent film is made of a polycarbonate resin material as a main ingredient.

10. The liquid crystal display device according to claim 7, wherein the translucent film has a thickness ranging from 0.1 to 0.2 mm.

11. The liquid crystal display device according to claim 7, wherein the retaining member is a screw.

12. The liquid crystal display device according to claims 7, wherein the retaining member is the frame or a packing.
